(19) United States
(12) Patent Application Publication
(10) Pub. No.: US 2012/0067297 A1
(43) Pub. Date: Mar. 22, 2012

(54) Hands-free restraining and control device for pets and children

(76) Inventor: Reinaldo Reyes, Sarasota, FL (US)

(21) Appl. No.: 12/807,892

(22) Filed: Sep. 16, 2010

(51) Int. Cl. A01K 27/00

(52) U.S. Cl. 119/792; 119/857

(57) ABSTRACT

The present invention comprises a hands-free device for restraining and controlling pets (mostly dogs) and small children. The device allows a person to walk pets and children allowing for a host of conveniences, heretofore not available. The invention has three main elements: (1) a Hip Strap; (2) a sliding component called the “Slider;” and (3) a hands-free retractable leash connected to the “Slider.” The user wears the device at the hips below the waistline adjusting hip belt at his/her convenience. By connecting the end of the hands-free retractable leash lead to a dog collar, or a child's harness, user is ready for walking. To accommodate user's needs, the device is adaptable for light, medium, and heavy pulling forces. Additional features may be incorporated such as reflectors and other safety features.

### BACKGROUND OF THE INVENTION

The present invention relates to the field of dog leashes. More particularly to the kind of leash that is worn by the user in one form or another attached in several ways and that allows free-hand operation when walking a dog. The concept and use of hands-free dog leash has been demonstrated in prior art. Below I submit the following patents relevant to the field of the present invention:

The Werner invention (U.S. Pat. No. 7,467,604) features a belt worn around the waist of user having a buckle in the front and a strap or cord affixed to the back of the belt as a means to attach a standard dog leash when jogging with a dog. This invention does not have the means for the use of a hands-free retractable dog leash.

The Perrulli invention (U.S. Pat. No. 5,958,569) features a belt to be worn around waist of user with a rope of cord affixed to the belt loosely hanging as a loop on which a pulley is attached by connecting means and from which a standard dog leash is attached. This invention does not have the means for the use of a hands-free retractable dog leash.

### BRIEF SUMMARY OF THE INVENTION

The present invention comprises a hands-free device for restraining and controlling pets (mostly dogs) and small children. The device allows a person to walk pets and children allowing for a host of conveniences, heretofore not available. The invention has three main elements: (1) a Hip Strap; (2) a sliding component called the “Slider;” and (3) a hands-free retractable leash connected to the “Slider.” The user wears the device at the hips below the waistline adjusting hip belt at his/her convenience. By connecting the end of the hands-free retractable leash lead to a dog collar, or a child's harness, user is ready for walking. To accommodate user's needs, the device is adaptable for light, medium, and heavy pulling forces. Additional features may be incorporated such as reflectors and other safety features.

### BRIEF DESCRIPTION OF THE SEVERAL VIEWS OF THE DRAWINGS

FIG. 1—Schematic of “Slider” installed at the Hip Strap with Interior Elastic Band.

FIG. 2—Schematic of “Slider” showing “Hip Strap,” Interior Elastic Band and Hands-Free Retractable Leash, Non-swiveled.

FIG. 3—Schematic of “Slider” showing Hip Strap, Interior Elastic Band and Hands-Free Retractable Leash Fully Swiveled.

FIG. 4—Plan and Elevations of “Slider” Without Mounting Bracket.

FIG. 5—Plan and Elevations of “Slider” With Mounting Bracket.

FIG. 6—Schematic of the Assemblage of “Slider.”

FIG. 7—Cross Section of Hip Strap and its Insertion Through “Slider.”

FIG. 8—Schematic of Housing for a Hands-Free Retractable Leash, Non-swiveled.

FIG. 9—Schematic of Housing for a Hands-Free Retractable Leash, Non-swiveled Mounted on “Slider.”

FIG. 10—Schematic of Housing For a Hands-Free Retractable Leash Fully Swiveled.

FIG. 11—Schematic of Housing For a Hands-Free Retractable Leash Fully Swiveled Mounted on a “Slider.”

FIG. 12—Schematic of the Invention Depicting a Mounting with A Ring for Use with a Conventional Hand-Held Leash.

Annex—Artistic Drawing Showing a Woman Walking Dog Using a “Hands-Free Restraining and Control Device For Pets and Children.

### DETAILED DESCRIPTION OF THE INVENTION

This Application claims benefit of the filing date of the Provisional Application No. 61/276,845, Sep. 17, 2009, as the priority date of the non-provisional application.

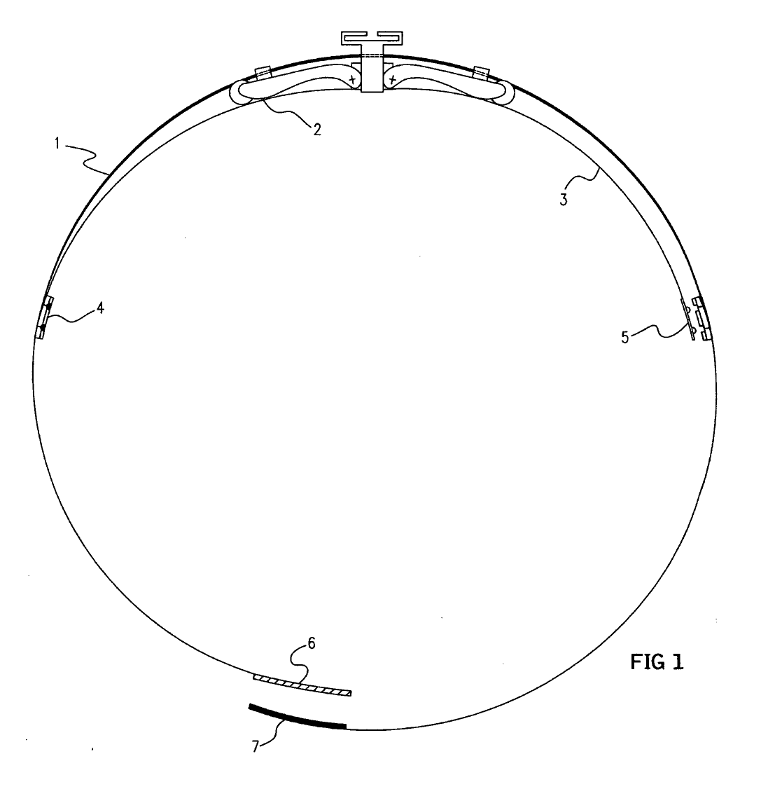

In FIG. 1 the Hip Strap (1) is shown installed through the “Slider” (2), an elastic interior band (3) is shown attached to the back of the Hip Strap (1) by rivets (4) on its left side and by snap-ons (5) on its right side, Velcro strips (6) and (7) are glued on the Hip Strap (1) at each open end.

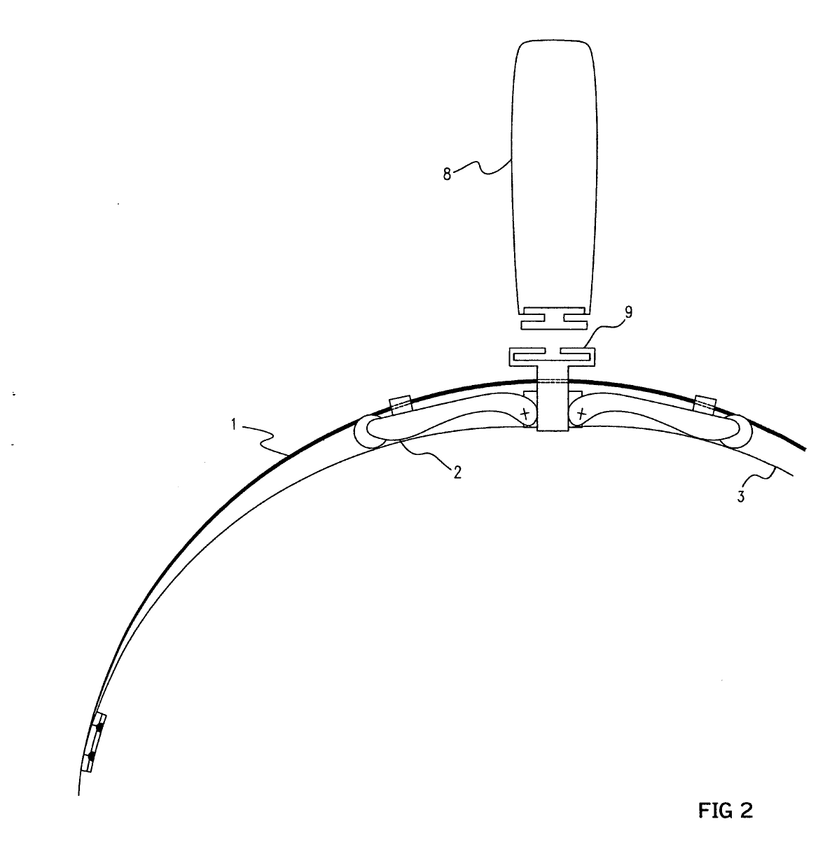

In FIG. 2 a non-swiveled hands-free retractable leash housing (8) is shown to be connected into the seating bracket (9) of the “Slider.”

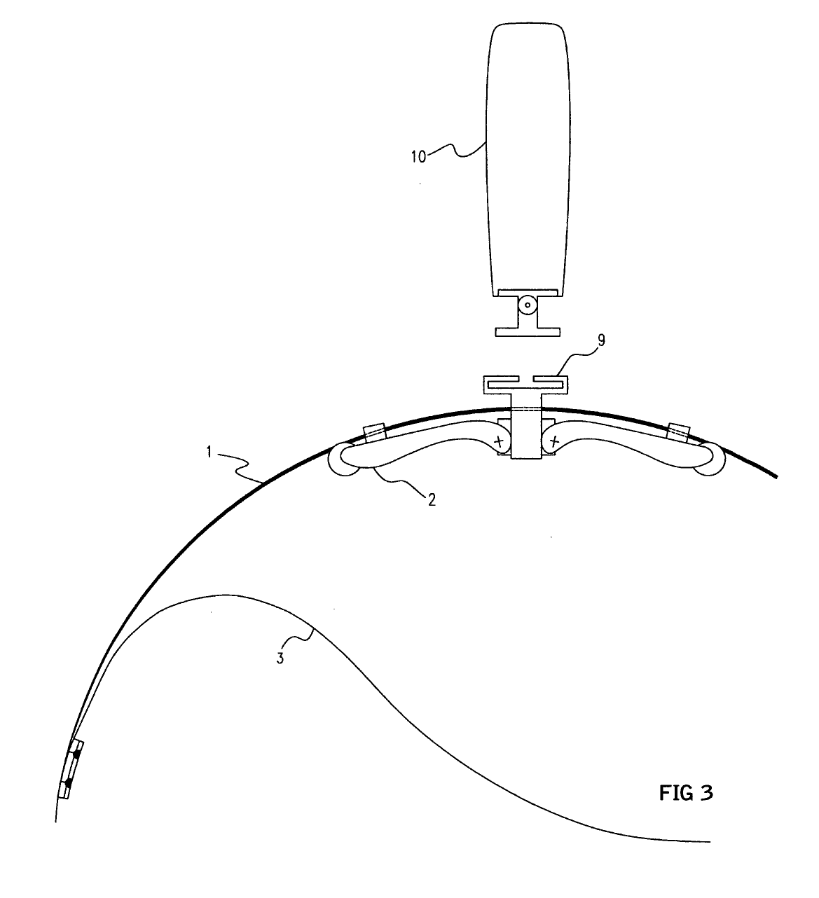

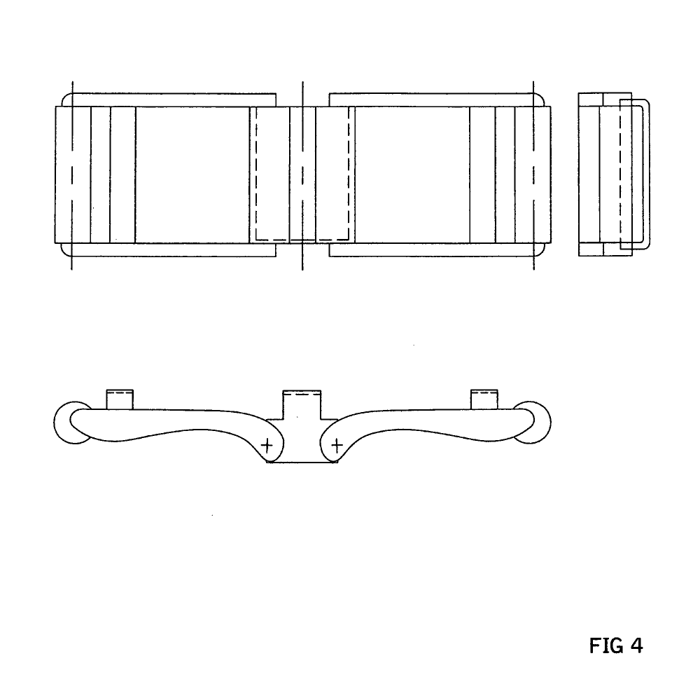

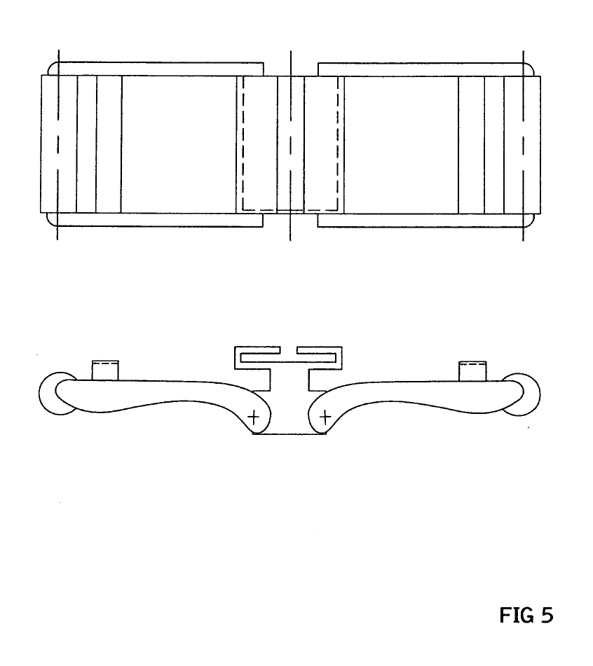

In FIG. 3 a fully swiveled hands-free retractable leash housing (10) is shown to be connected to “Slider” (2) seating bracket (9).

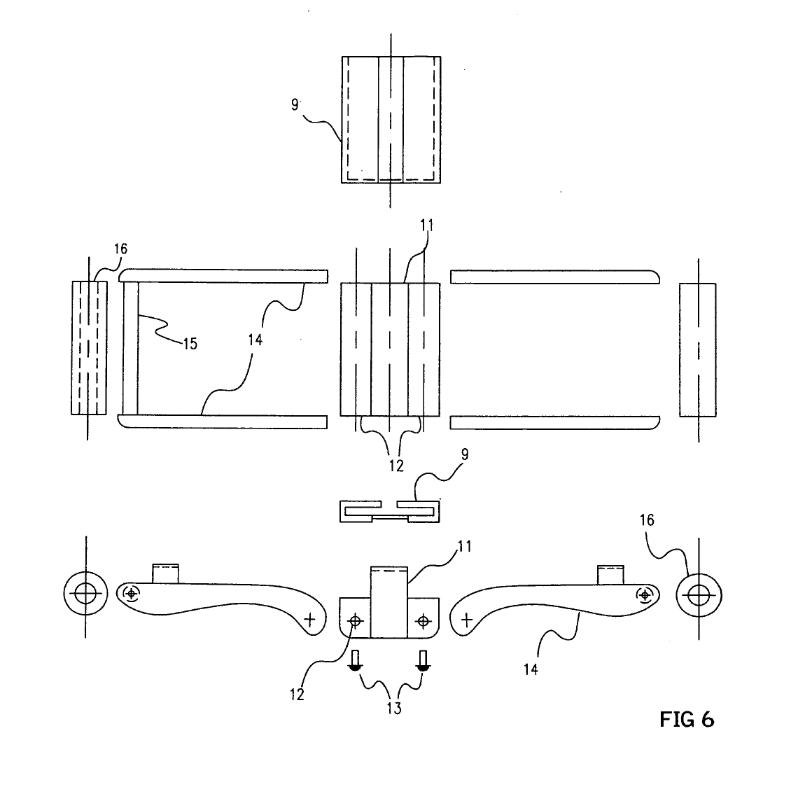

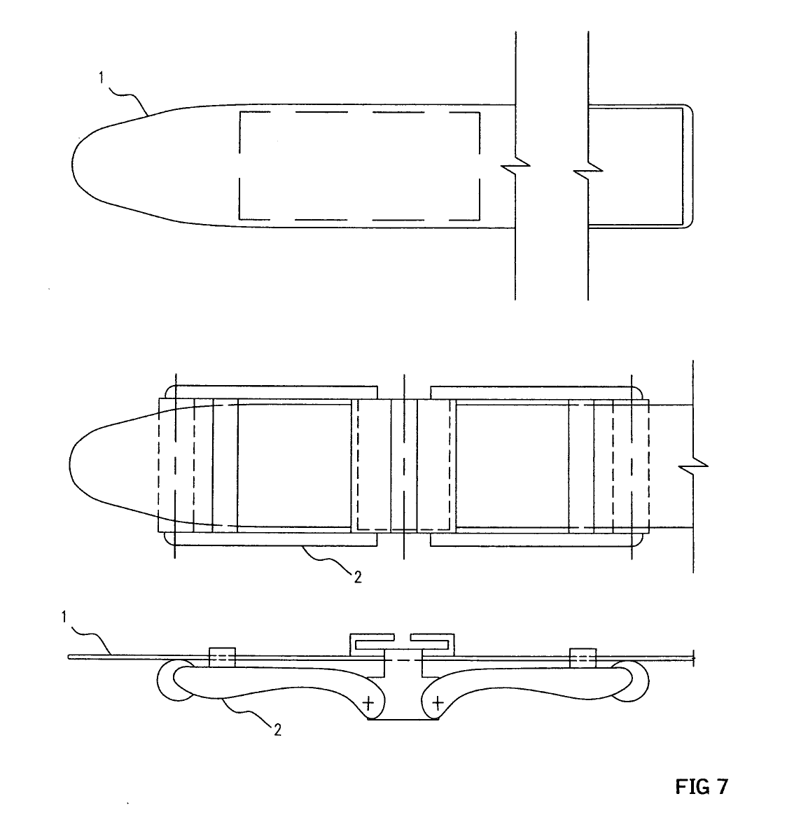

FIG. 6, Schematic of the Assemblage of “Slider,” shows the center section (11) with holes (12) to receive pressure studs (13) to affix to the “Slider's” legs (14) and axle (15) to be inserted through center hole of cylindrical rollers (16), both affixed to “Slider's” legs (14) at each end. Seating bracket (9) is shown to be joined at center section (11) of “Slider.”

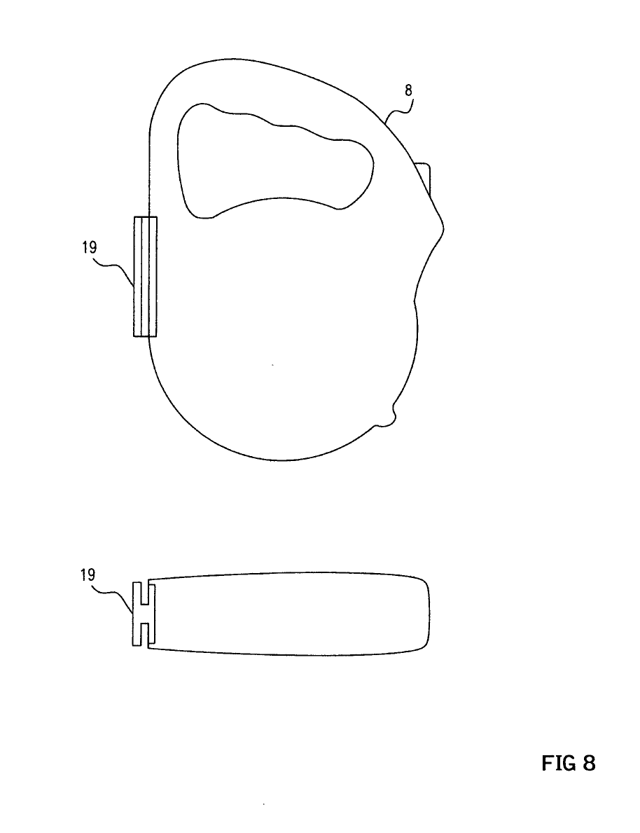

FIG. 8 illustrates the housing (8) of the hands-free retractable leash, non-swiveled, and its “H” connector (19).

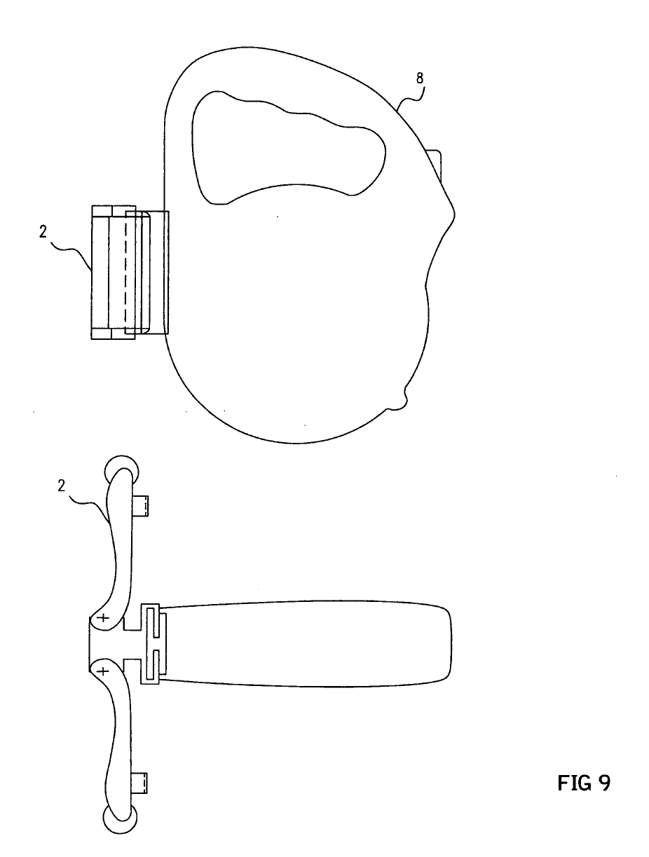

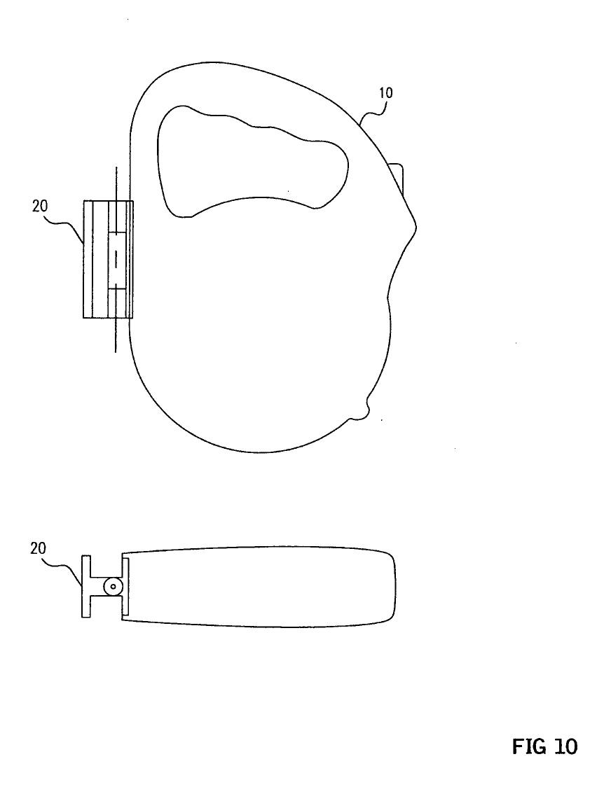

FIG. 9 shows the housing (8) of the hands-free retractable leash, non-swiveled, connected to the “Slider” (2).

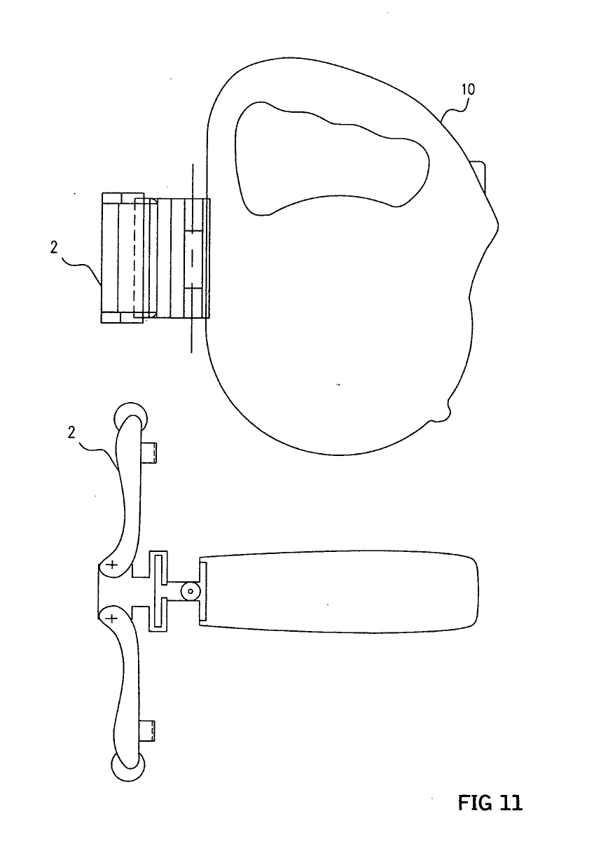

FIG. 10 shows the housing (10) of the hands-free retractable leash, fully swiveled and its hinged connector (20).

FIG. 11 illustrates the housing (10) of the hands-free retractable leash, fully swiveled connected to the “Slider” (2).

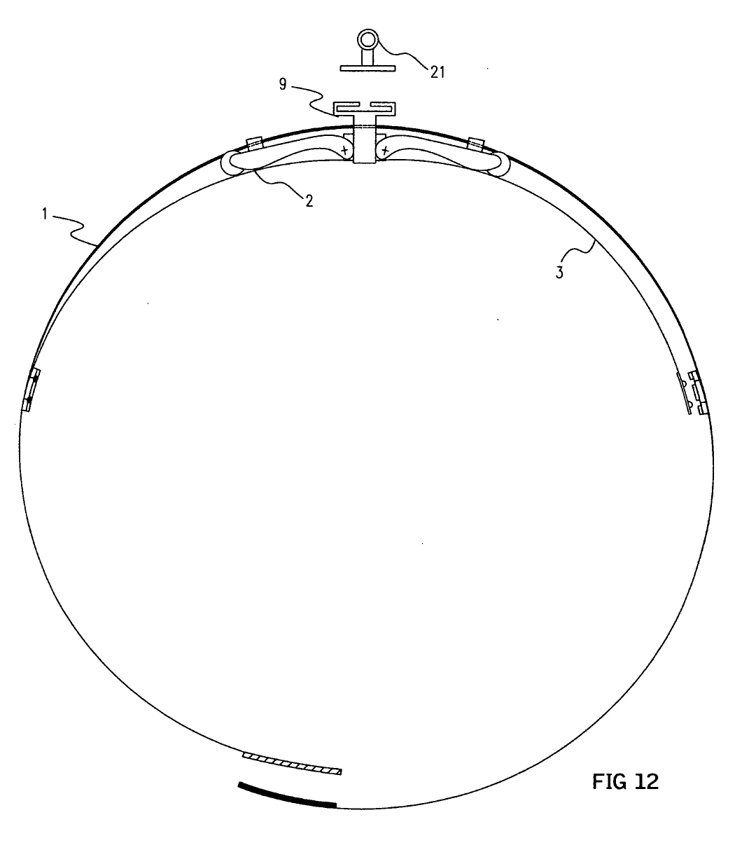

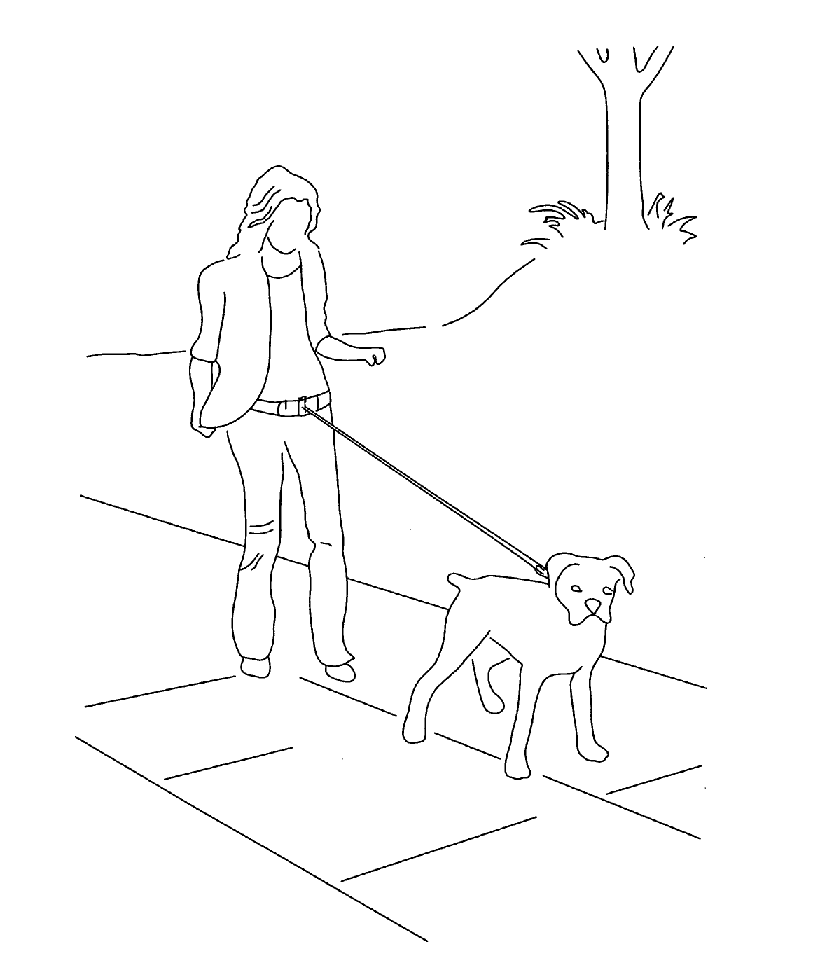

FIG. 12 shows a ring connector (21) for a hand-held leash to be connected to “Slider” (2) and its receiving bracket (9).

The Annex is an Artistic Drawing Showing a Woman Walking Dog Using a “Hands-Free Restraining and Control Device For Pets and Children.”

A hands-free device for restraining and controlling dogs and small children while walking. This hands-free device allows a person to walk pets and children allowing for a host of conveniences to the user heretofore not available by any other means.

The device of this application comprises, as its first element, a strap to be worn by the user over the hip region of the body, below the waistline, hereinafter, “The Hip Strap.”

A second element of the device comprises a sliding component to be placed through the Hip Strap, allowing motion along the strap, hereinafter the “Slider.”

A third element of the device comprises a hands-free retractable leash removably connected to the second element the “Slider.”

The Hip Strap has no buckle, thus open ended. The strap is secured around the user's hips by connecting means, including “Velcro,” grommets, snaps, pegs through holes, laces or any other convenient fasteners. Strap materials may be leather, plastics, textiles or any other suitable material. Straps may be produced in a plurality of widths and lengths to conform to user's girths. These may be offered in a variety of colors and designs to suit user's taste, male or female. The Hip Strap incorporates an elastic band situated back of the strap.

The “Slider” component of the device is configured to easily slide along the Hip Strap. The “Slider” may be made in a plurality of designs and materials, one design would consist of two sections hinged together having two rectangular sleeves to allow the “Slider” to move along the strap, acting also as restraining guides. The “Slider” comprises a holding bracket or seat to receive the third element of the device under this application, the hands-free retractable leash. It is configured to also allow attachments for conventional hand-held leashes.

The retractable leash mounted on the “Slider” of the Hip Strap will allow user to have a hands-free operation, enhancing restrain and control while walking a dog or strolling with small children. This retractable leash is configured to conform to the other two elements of the device under this application, so as to operate as a hands-free retractable leash. It is to seat in the “Slider” without impairing user's movement as well.

The retractable leash will have the conventional spring-loaded mechanism for cable or tape leashes as known commercially but configured to conform to the present invention. The housing of this retractable leash will sit at the center section of the “Slider” with the ability to change its orientation in conformity with the direction of travel along the Hip Strap. It is to be positioned on the “Slider” facing front that is, along the axis that cuts along the feed of the leash.

Finally, the housing of the retractable leash incorporates connectors for affixing to the “Slider.” This will enable the leash housing to sit hands-free in the “Slider.” The bracket or seat at the “Slider” is designed to accept both hinged and unhinged solutions. As a hinged solution it will allow the hands-free retractable leash to swivel omni-directionally. After use the retractable leash may be easily removed for storage. To accommodate user's needs, the device is adaptable for light, medium and heavy pulling forces. Other features may be incorporated such as reflectors and other safety features.

Operation of the Device:

(1) User first installs the “Slider” passing one end of the Hip Strap through the guides and body of the “Slider.” Next, the user clips on the elastic band at the back of the Hip Strap. The “Slider” is now positioned between the Hip Strap and the elastic band. Lastly, the user affixes the Hip Strap to hips by reaching back, fastening the ends of the straps by connecting means. Once positioned in this manner, the “Slider” will easily glide either to the right or the left along an arc of no less than 100 degrees, from center of hips. Next, the user connects the hands-free retractable leash to the “Slider.”

(2) The movement of the “Slider” will respond to the forward pull of a pet or child and its movement center to right or center to left. The user may conveniently control the positioning of the “Slider” along the Hip Strap by locking it down. The user may also lock down the “Slider” along any point of the 100 degree arc. This is very convenient when walking two dogs or a dog and a child.

(3) By the addition of the third element, a hands-free retractable leash mounted on the “Slider,” the user gains advantages heretofore unavailable. Once the Hip Strap is fitted around the hips below the waistline, user attaches one end of the leash lead to the collar of the dog (or child harness) and snaps in the hands-free retractable leash connector into the bracket or seat of the “Slider,” at the front of the Hip Strap. As the dog (or child) moves forward and to the sides, the “Slider” at the Hip Strap shifts according to the direction that the dog (or child) is walking. The user may give more leash (lead) as well as to retract leash at user's convenience.

Advantages of the Device:

(1) Hands-Free Operation. Having hands free allows a person to do other things concurrently when walking a pet (dogs mainly) or a child. A cell phone may be operated, car trunks and doors easily opened, grocery bags carried, a baby carriage controlled using both hands, walking a child using a second leash, carrying an open umbrella and many other things.

(2) Better Leverage and Control. The position of the device at the hip allows the user to place his/her full weight behind the pulling force of the pet or child creating enhanced balance and control. Furthermore, the major muscles of the body such as torso, thighs, and lower back, combine together to easily oppose the pulling force, in contrast to weaker arm and shoulder muscles. A strong or jerky pulling force may injure a wrist, fingers, and hand when using a conventional leash. Arthritic persons may be spared the strain and pain of such use.

(3) Directional. The device allows user to select the position of the leash lead along any point of a 100-degree arc of the Hip Strap. This will permit user to walk a dog to the right or left of the body, subject to safety considerations. The device allows user to walk two dogs at the same time or walk a child along with a dog. The user may elect to use the device of this invention with the hands-free retractable leash disconnected from the sliding component at user's convenience. The user may elect to use a conventional hand held leash hands free under certain circumstances still maintaining the hands-free retractable leash in the “Slider.”

Preferred Method:

(1) The first element of the device, the Hip Strap, could be configured in a plurality of materials and produced in various designs; however the preferred embodiment under this application is as follows:

“A strap made out of a high grade flexible plastic such as, but not limited to, vinyl. The strap has Velcro strips at each end of the strap as means of connection. The strap has a width of 1¾″ (inches), a thickness of 5/32″ (inches) and made in a plurality of lengths of lengths.” The interior elastic band is made of rubberized polyester, affixed to the back of “Hip Strap” by snaps at one end and rivets at the other end. This band has a width of 2¼″ (inches) and 1/16″ (inches) thickness.

(2) The second element of this device, the “Slider,” could be configured in a plurality of designs and materials; however the preferred embodiment is as follows:

“A metallic assembly comprising two hinged sections with rectangular sleeves to serve as strap guides and cylindrical rollers at each end. The ‘Slider’ incorporating a bracket or seat to receive the third element of the device under this application.”

(3) The third element of the device, the hands-free retractable leash, embodies features to permit its installation on the second element of the device under this application.

“A retractable leash similar to those commercially known in the industry but comprising features for a new application with the present invention. The features or embodiments are a housing and connectors specifically designed for use with the present invention. As such, it will become a “hands-free retractable leash” and the preferred embodiment under this invention.

Please see drawings for better understanding.

Summary of Preferred Method: The preferred embodiment for the device under this application is as follows:

(1) A Hip Strap comprised of vinyl or other flexible plastic, fastened with Velcro strips with a width of 1¾″ (inches) and thickness of 5/32″ (inches) and variable lengths, having an interior elastic band 2¼″ (inches) wide by 1/16″ (inches) thick.

(2) A metallic component, the “Slider,” comprised of two sections hinged together with rectangular sleeves at each section to serve as guides and restrainers, and cylindrical rollers at each end to facilitate travel along the Hip Strap and a bracket or seat at its center for installing a hands-free retractable leash as well as a locking pin for securing the sliding assembly in place as convenient to user. It is designed to also allow attachment for conventional hand-held leashes.

(3) A hands-free retractable leash so comprised that its housing fits into the bracket or seat of the “Slider” and allowing removal for storage. The hands-free retractable leash will be procured to specifications for the purpose of the present invention. The preferred method incorporates a fully hinged retractable leash to allow no less than 150 degrees swivel or swing at center of “Slider.”

Reference drawings for better understanding.

Other Embodiments: The present invention comprises a sliding element (the “Slider”) that constitutes the most important feature of the invention and is critical for its functioning as a hands-free restraining and control device for walking pets and children. An embodiment of the invention could comprise a hollow rectangular component having many sections hinged together so that the rectangular component is able to travel along the Hip Strap encasing the Hip Strap as it travels, incorporating a seating bracket to receive a retractable leash.

A second embodiment of the invention could be a plurality of roller bearings connected together inside a rectangular shape that would slide over the exterior side of the Hip Strap or over its interior side.

As changes may be made in the apparatus described herein without substantial departure from the scope of the invention, all matter contained in this description and illustrated in the enclosed drawings should be interpreted as illustrative only and not as limiting.

1. In relation to the Hands-Free Restraining and Control Device for Pets and Children, a Hip Strap to be worn over the hips below waistline of user having means of attachment at the back of the user and having an internal elastic band to be affixed to the underside of Hip Strap, the Hip Strap of claim 1 comprising adjustable ends and means for attaching behind the back of user, the Hip Strap of claim 1 wherein a rubberized elastic band is affixed to the back of the Hip Strap so as to be in contact with the clothing of the user, the Hip Strap of claim 1 wherein the Hip Strap's elastic band is affixed at two opposite points at the back of the Hip Strap and connected by various means.

2. In relation to the Hands-Free Restraining and Control Device for Pets and Children, a component both slidable and affixable for installation at the Hip Strap of claim 1, such component configured to shift or slide from side to side at the front of Hip Strap when worn by user, comprising a double-hinged mechanism incorporating rollers and guides at each end to allow easy movement along an arc of Hip Strap, and a receiving bracket configured to sit at the center of the slidable and affixable component for connecting a third component under this application.

3. In relation to the present invention, a hands-free retractable leash configured to allow installation at the front center of the slidable and affixable component of claim 2 so as to travel from side to side of the front of Hip Strap of claim 1, the hands-free retractable leash comprising a spring-loaded mechanism as commercially available in the industry, connected to the receiving bracket of claim 2, to allow the hands-free retractable leash to slide or shift from side to side along an arc of no less than 100 degrees along the Hip Strap of claim 1 and to swivel omni-directionally no less than 150 degrees at its hinged connection on the slidable and affixable component of claim 2.
